(19) United States
(12) Patent Application Publication
(10) Pub. No.: US 2002/0138555 A1
(43) Pub. Date: Sep. 26, 2002

(54) Client enhanced server-side cache system

(76) Inventor: Allen Kai-Lang Yu, Sunnyvale, CA (US)

Correspondence Address: HEWLETT-PACKARD COMPANY, Intellectual Property Administration, P.O. Box 272400, Fort Collins, CO, 80527-2400, US

(21) Appl. No.: 09/816,994

(22) Filed: Mar. 23, 2001

(51) Int. Cl. G06F 15/16

(52) U.S. Cl. 709/203; 709/213

(57) ABSTRACT

A method for extending the lifetime of cached web pages. In multi-user environments, as for example in networks, that require the display of personalized information for each client served, regeneration has been required for even the simplest of changes. This regeneration can become an excessive burden on heavily loaded web servers and can cause major, unacceptable performance degradation. Methods are disclosed herein for significantly reducing the incidence of required regeneration of cached pages in such systems. The load on the server is reduced by moving much of the regeneration of information pages to the clients that become the systems responsible for generating most of the personalization modifications. Differences between cached versions can be abridged with client-side scripts, so only one master cache version, instead of multiple minor variation versions, need to be generated on the server, resulting in high cache efficiency and server performance. These techniques are applicable to file-cache enabled web servers.

### FIELD OF THE INVENTION

The present invention relates generally to networks and, more particularly, to file-cache enabled web servers, and even more particularly to the extension of cached page lifetimes in such systems.

### BACKGROUND OF THE INVENTION

A computer's central processing unit (CPU) often operates at a much faster speed than does its input-output (IO) devices, including file system storage devices among others. Even as file access times improved, CPU speeds also inevitably grew even faster. The bottleneck produced by file IO quickly became one of the primary limiting factors in computer performance. Caching was developed in order to alleviate this performance problem. Traditionally, a cache refers to a random access memory (RAM) cache. It stores the most recently or commonly used bits of codes or data in order to increase the overall speed of the system. A performance gain is obtained by the inherent faster speed and greater accessibility of dynamic memory as opposed to that used by the file system. Instead of retrieving instructions or data which it will most likely use again from its relatively slow file system, the computer uses the RAM cache to anticipate which data and instructions the computer will most often use again and holds them in the much faster dynamic memory system. This way, the next time such data and instructions are needed by the computer, it can retrieve them quickly from the cache with the result that the CPU does not have to wait for retrieval from the slower file system.

Caching, however, does not always refer to the RAM cache described above. In fact, whenever a speed differential exists between two interacting media, performance gain can be achieved by developing a cache that stores the more commonly used data on the faster media. In docroot or file system based caching, information from the database, which in this case is the slower media, is cached on the server's docroot or file system, which in this case is the faster media, to speed up performance. Such caching is effective because database calls are much slower than file retrievals. Database calls, in general, form one of the main performance bottlenecks in today's fast dynamic web servers.

Web servers typically have a location in their file system where all web pages are stored called the docroot which is an acronym for document root. The caching scheme just described typically utilizes this docroot location for storing its cache content and is, therefore, referred to herein as a docroot-based caching system, as well as a file-based caching system. The main advantage of using such a system, as mentioned, is performance gain. By caching commonly used database retrieval results on the web server, repeat requests made by, for example, multiple customers can be made without incurring extra database calls as long as the database information remains unchanged. In case that relevant information in the database has changed, the cached information will be deleted, the database re-queried, and the new information re-cached to the file system. Subsequent requests will be retrieved from the file system until data in the database changes again and the cycle repeats. In general, while some overhead is involved in the design of a website that incorporates such a caching scheme, with proper design, the benefits can be substantial.

The following is a more detailed discussion of the caching of customized content in cache enabled web servers. Docroot-based Caching Systems (DCSs), are implemented by employing a fundamental mechanism referred to as server-side include (SSI). Server-side include for web servers allows the web site developer to in effect copy codes from an external file and paste those codes over the section where he has specified the include statement. All modern web servers support server-side include as it allows developers to modularize program code into more management chunks and to share commonly used codes across an entire website.

In today's e-commerce and information driven web pages, a large number of pages on a web site need to be dynamically generated in order to present useful, compelling, personalized content. Because each such generation result in at least one database call, the cost in terms of system resources used for custom generating a page on a per user basis can be high and often causes major degradations in server performance.

However, not every page needs to be custom generated in order to deliver customized content. In fact, most of the personalized pages traditionally crafted for each individual contain components can be shared among a large number of users who have analogous needs or interests. A caching scheme that takes advantage of the sharing of such information can lead to tremendous performance gains.

As an example, suppose a news site offers 5 types of news headline services: international, national, science & technology, business, and sports, and further suppose that a user is allowed to subscribe to any combination and any number of these headline services. Traditionally, a headlines page would be dynamically re-generated from the database for each user. However, with docroot-based caching systems, news headlines can be stored as static HyperText Markup Language (HTML) files in the docroot, and the page each user sees is custom built from these shared headline components without database calls. While cached components are often implemented in HTML, they can in general be in any format, including the internet information exchange standard Extensible Markup Language (XML). Such cached information can be used to serve a variety of client devices such as HTML browsers, voice interface devices, low screen resolution display, as for example in Personal Digital Assistants (PDA's), pagers, mobile phones, etc. A performance gain is realized because in generating each customized page, all database calls are reduced to file system retrievals. Consequently, database calls can be made on an event-triggered basis—i.e., only when data in the news database changes. The information is obtained with server-side includes—which is relatively inexpensive in terms of system resources when compared with database retrievals.

As a general rule, the more the ratio of number-of-users to the number-of-cached versions can be increased for a given web page, the greater the performance can be increased. In other words, the website should be designed so that each cached component is shared with as wide an audience as possible. Thus, there is a need for a system for improving the effectiveness of docroot-based caching systems by lowering the number of versions of pages of information that are required to be cached.

### SUMMARY OF THE INVENTION

In representative embodiments, methods are described for extending the lifetime of cached web pages. In multi-user environments, as for example in networks, that require the display of personalized information for each client served, regeneration has been required for even the simplest of changes. This regeneration can become an excessive burden on heavily loaded web servers and can cause major, unacceptable performance degradation. Methods are disclosed herein for significantly reducing the incidence of required regeneration of cached pages in such systems. The load on the server is reduced by moving much of the regeneration of information pages related to personalization to the clients. These techniques are applicable to file-cache enabled web servers. The performance of the system is enhanced because the server is burdened to generate only a single version, or at most a few versions, of a personalized page.

Performance gains in cached systems can be improved by lowering the number of cached versions of a certain page or, equivalently, by sharing cached version among as many users as possible. As disclosed herein in representative embodiments, differences between cached versions can be bridged with client-side scripts, so only one master cache version, instead of multiple minor variation versions, need to be generated, resulting in high cache efficiency and server performance.

Methods disclosed herein are illustrated in two example applications which boost performance in server-side file system based caching, i.e., in docroot-based cache systems. The first application relates to a situation which could be, for example, faced by multi-national companies whose web pages contain network addresses that change according to the connecting user's geographic location. The challenge facing these companies is to incorporate caching in its website while enabling linked network addresses to adapt to user geography. The second application discusses a situation faced, for example, by companies that want to personalize their pages by custom tagging their contents on behalf of each user. Each user may pick a different criterion for tagging the content, so even though the underlying content is the same, the resultant page, with these custom tags, appears different for each user. The challenge with which these companies is faced is to design websites that implement this tagging functionality without abandoning the old caching schema, which would require the regeneration of customized pages for each customer.

As used herein, the term web page is synonymous with network page, and can include blocks or pages of information which are transmitted from a server computer to a client computer/device in a variety of multi-user systems. Also as used herein the term web page means more than just HyperText Markup Language (HTML) which is the most commonly used document format on today's Internet web pages. The concepts disclosed herein can be applied equally well to low resolution documents that serve mobile and wireless devices such as personal digital assistants (PDA's), pagers, and mobile phones; to audio documents that serve devices such as those used by the visually impaired; to hyper documents that serve the various virtual reality devices; to Internet enabled appliances; etc. Similarly, by cached files, HTML-formatted files are not implied. These files can be any generic files in any format used to store cached database information. They can be Extensible Markup language (XML) formatted, for example, and store—in addition to HTML content—images, sounds, and all other binary content. Finally, client-side functions, such as JavaScript functions, refer to all client-interpreted languages—not just client-side formatting languages such as JavaScript and VBScript. The client functions, in addition to operating on parameters provided by the web server, can interact with preference settings on the client, data stored on the client, or even information retrieved from other web services referenced by the client.

The methods disclosed above can be easily implemented in numerous web presentation technologies including but not limited to those implemented in the commercial web page generation technology products Vignette, Java Server Pages (JSP), Active Server Pages (ASP), and Common Gateway Interface (CGI), so long as some type of a file system based cache supporting infrastructure exists. Regardless of the technology, the fundamental goal is to extend a cached page's lifetime even when new personalization requirements are needed. In the above discussions, two cases have been disclosed wherein personalization is achieved on top of cached web pages. Links can be personalized to take on different behaviors based on user preference. Images can be turned on or off according to user preference. However, these methods have application beyond link target modification and image on/off display. Links can be associated with customized JavaScript functions to carry even more complicated customized tasks on behalf of the user. Whole sets of images and texts can be substituted, emphasized, hidden or displayed for a more personalized web experience. These can all be done in the context of a high performance, docroot-based caching web site.

A primary advantage of the embodiment as described in the present patent document over prior methods for caching page content in multi-user environments is the ability of the methods disclosed herein to increase the effectiveness of docroot-based caching systems in the context of the two contradictory demands of greater personalization and higher performance. The mechanism proposed to reconcile some of this dilemma is to use client-side processes, as for example JavaScript, to enable customization to be performed on the client side so that only one, or perhaps at most a few, master cashed versions are needed on the server. A primary goal of the methods disclosed is to maintain as few versions of cached components on the server for as many clients as possible for as long as possible prior to having to regenerate the cached information to increase server performance. Methods described herein provide techniques for attaining this goal.

For example, by writing the date that a particular page or segment of a page was modified to that page as an invisible field, client side processes, as for example java scripts, can detect whether to display new information, as for example a “new” icon, or not without using any server resources. The cached pages can remain cached until new real content is added. It's common to have multiple servers serving different geographical regions—i.e., different servers for Europe, Asia, and America. When pages are cached and transferred between sites, the pages might have to be re-rendered just because certain links now point to different servers. It is also common for login synchronization that pages are a combination of dynamically rendered and statically cached pages. The dynamically rendered side can store server links into either hidden trays on the page or in cookies. Than cached page can remain cached and fetch the dynamic information from the dynamic part via JavaScript.

Other aspects and advantages of the present invention will become apparent from the following detailed description, taken in conjunction with the accompanying drawings, illustrating by way of example the principles of the invention.

### BRIEF DESCRIPTION OF THE DRAWINGS

The accompanying drawings provide visual representations which will be used to more fully describe the invention and can be used by those skilled in the art to better understand it and its inherent advantages. In these drawings, like reference numerals identify corresponding elements and:

FIG. 1 is a drawing of a server-to-client transmitted page retrieval as described in various representative embodiments of the present patent document.

FIG. 2 is a drawing of another server-to-client transmitted page retrieval as described in various representative embodiments of the present patent document.

FIG. 3 is a drawing of a server/client system as described in various representative embodiments of the present patent document.

FIG. 4 is a flow chart of a method for display of client enhanced server-side cache pages as described in various representative embodiments of the present patent document.

### DETAILED DESCRIPTION OF THE PREFERRED EMBODIMENTS

As shown in the drawings for purposes of illustration, the present patent document relates to novel methods for extending the lifetime and/or scope of certain categories of cached pages. Previous methods for employing cached pages in networks in general have required regenerating a different version of a page for every variation of content presentation. Regeneration would have been required for even the simplest of changes. In multi-user environments, as for example in networks, requiring the display of personalization information, this regeneration can become an excessive burden on heavily loaded web servers and can cause major, unacceptable performance degradations. Methods are disclosed herein for significantly reducing the necessary regeneration of cached pages in such systems.

In the following detailed description and in the several figures of the drawings, like elements are identified with like reference numerals.

1. Introductory Comments:

Performance gains in cached systems can be improved by lowering the number of cached versions of a certain page or, equivalently, by sharing cached version among as many users as possible. As disclosed herein in representative embodiments, differences between cached versions can be abridged with client-side scripts, so only one master cache version, instead of multiple minor variation versions, need to be generated, resulting in high cache efficiency and server performance.

Representative embodiments of the methods disclosed herein are illustrated in two example applications which boost performance in a docroot-based cache system. The first application relates to a situation which could be, for example, faced by multi-national companies whose web pages contain network addresses that change according to the connecting user's geographic location. The challenge facing these companies is to incorporate caching in its website while enabling linked network addresses to adapt to user geography. The second application discusses a situation faced, for example, by companies that want to personalize their pages by custom tagging their contents on behalf of each user. Each user may pick a different criterion for tagging the content, so even though the underlying content is the same, the resultant page, with these custom tags, appears different for each user. The challenge with which these companies is faced is to design websites that implement this tagging functionality without abandoning the old caching schema, which would require the regeneration of customized pages for each customer.

2. Discussion:

In representative embodiments, methods are disclosed for reducing the regeneration of cached informational web pages. Concepts disclosed are applicable to server-side file system based caching strategies, as for example server-side docroot based caching strategies.

As used herein, the term web page is synonymous with network page, and can include blocks or pages of information which are transmitted from a server computer to a client computer in a variety of multi-user systems. Also, as used herein the term web page means more than just HyperText Markup Language (HTML) pages which is the most commonly used document format on today's Internet. The concepts disclosed herein can be applied equally well to low resolution documents that serve mobile and wireless devices such as personal digital assistants (PDA's), pagers, and mobile phones; to audio documents that serve devices such as those used by the visually impaired; to hyper documents that serve the various virtual reality devices; to Internet enabled devices; etc. Similarly, cached files do not simply imply HTML-formatted files. These files can be any generic files in any format used to store cached database information. They can be Extensible Markup Language (XML) formatted, for example, and store—in addition to HTML content—images, sounds, and all other binary content. Finally, client-side functions, such as JavaScript functions, refer to all client-interpreted languages—not just client-side formatting languages such as JavaScript and VBScript. The client functions, in addition to operating on parameters provided by the web server, can interact with preference settings on the client, data stored on the client, or even information retrieved from other web services referenced by the client.

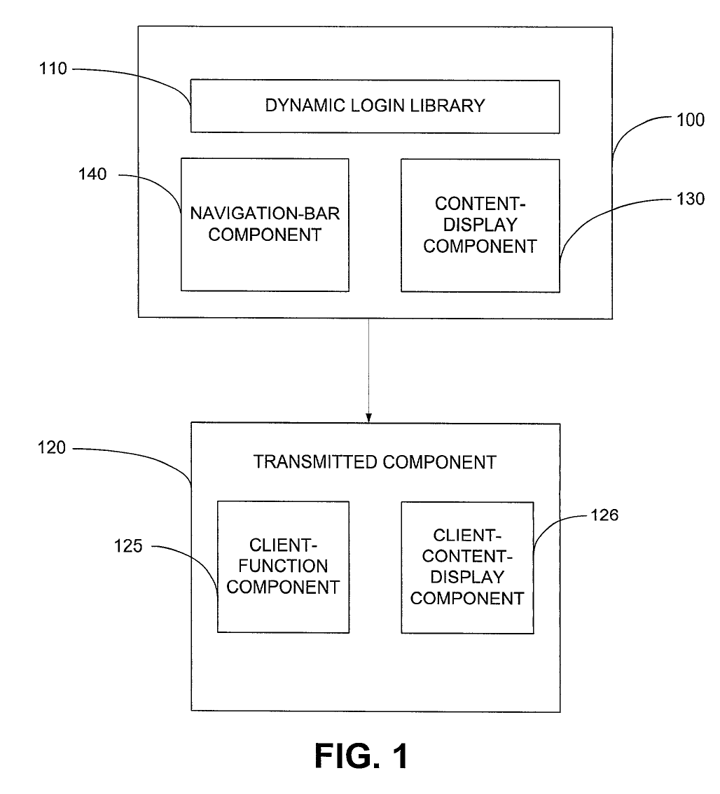

FIG. 1 is a drawing of a server-to-client transmitted page 120 retrieval as described in various representative embodiments of the present patent document. A server template 100 in FIG. 1 comprises components which, in this representative embodiment, the server maintains in order to create the information transmitted to the client to create the display on the client. The server template 100 comprises a dynamic login library 110, a content-display component 130, also referred to herein as a first information component 130, which is responsible for presenting most of the content of the web page to the user on the client system and a navigation-bar component 140 which is cached and which is responsible for displaying the navigational links to the user. The server uses the server template 100 to generate the server-to-client transmitted page 120, also referred to herein as the transmitted component 120 and as the second information component 120. The main purpose of the dynamic login library 110 is to determine whether a user is logged in, and if so to retrieve his/her account information. Typically the dynamic login library 110 makes calls to a database to obtain the necessary user information. The server transmits the transmitted component 120, to the client. Since the navigation-bar component 140 is cached, it is obtained from the server file system. A client-function component 125 is used by the client to modify a client-content-display component 126 to generate the final personalized version of the web page for display on the client. In the example of the next section, from the login information that it possess the dynamic login library 110 is used to generate, for example, target JavaScripts that provide custom functionality based upon user login information.

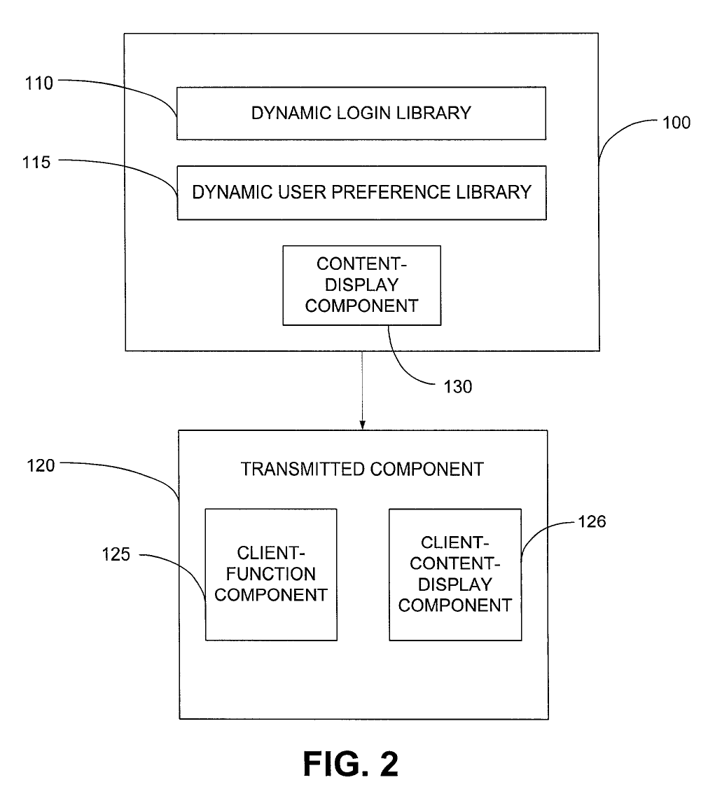

FIG. 2 is a drawing of another server-to-client transmitted page 120 retrieval as described in various representative embodiments of the present patent document. The server template 100 in FIG. 2 comprises components which, in this representative embodiment, the server again maintains in order to create the information that is transmitted to the client to create the display that is displayed on the client. Typically the server uses the server template 100 which comprises the dynamic login library 110, a dynamic user preference library 115, and the content-display component 130 which the server uses to generate the server-to-client transmitted page 120. Again, the main purpose of the dynamic login library 110 is to determine whether a user is logged in, and if so to retrieve his/her account information. Information from the dynamic login library 100 is used to obtain user specific preferences from the dynamic user preference library 115. The dynamic user preference library 115 is used to generate user specific parameters for a given functionality; in the second embodiment, this parameter refers to the threshold, in the number of days, under which a given item is to be considered new. The server transmits the transmitted component 120 to the client. As in FIG. 1, the client-function component 125 is used by the client to modify the client-content-display component 126 to generate the final personalized version of the web page for display on the client.

Use of dynamic login library 110 and dynamic user preference library 115 are implementation dependent. In particular, some implementations may use neither or only one of the libraries 110,115.

2.1 Navigation Bar Example:

The navigation-bar component 140 of FIG. 1 could be used by, for example, a multi-national company for navigation of their web page. The navigation-bar component 140 is typically cached while the content-display component 130 can be either dynamically created or cached, depending on its use. Other embodiments may comprise other components beyond those shown in FIG. 1.

The navigation-bar component 140 is an item commonly found on web pages that provides a context-sensitive list of links for the navigation of the web site. In an enterprise website environment, multiple servers around the world are often used to serve an international customer base. The link targets on the navigation-bar component 140 typically point to local servers in order for the global network of servers to function properly, as for example for language localization and/or for efficiency, for example by reducing international network traffic. Labels or tags leading the user to the link targets are a part of the navigation-bar component 140. A question that confronts the site designer is whether or not to design the navigation-bar component 140 as a dynamic or a cached component. On the one hand, the fact that the links need to dynamically reflect the customer and server locality suggests that navigation-bar component 140 should be dynamically generated. On the other hand, the fact that all users see essentially the same the navigation-bar component 140 for a given page even though the underlying links may point to different places, suggests that this component should be cached. This decision is not just for intellectual curiosity. Since the navigational component could exist on every web page of a given website, the ability to cache the navigation-bar component 140 and eliminate the need to dynamically regenerate that component each time the page is viewed would greatly enhance that website's performance.

In representative embodiments disclosed in the present patent document, the conflicting needs described above can be reconciled by caching the link texts but not the link addresses. Instead of pointing to real URL addresses, these links will point to client-side JavaScript functions that are dynamically generated for each user by the login library 110. Links in the navigation-bar component 140 would point to client-side functions typically JavaScript functions, rather than hard coded network addresses, such as world wide web uniform resource locators (URLs). These client-side functions would then redirect users to real, physical network addresses. It is important to note that this scheme is not just a trick to shift the burden of dynamic generation from the navigation-bar component 140 to the dynamic login library 110. To truly appreciate the scheme here, note that the dynamic login library 110 already contains access to user information and server configurations, so dynamically generating a JavaScript pointer functions places minimal burden on it. Further note that by having the links statically point to smart client-side functions that are custom built by the login library 110, not only does the navigation bar not have to reprocess information already processed by the dynamic login library 110, but the navigation-bar component 140 can now also be cached since it is free of the burden of knowing the actual target locations of these links.

In summary using the representative methods just disclosed, the navigation-bar component 140 can be cached while still being endowed with the required dynamic behavior. Improved performance is achieved by having only one version of a static file shared among all clients instead of dynamically regenerating a custom version for each client, even as the behavior of this component is personalized and customized for each client's locality. Regeneration of the navigation-bar component 140 would not be needed until the next version of the web site comes out. The performance gain by being able to cache commonly used components such as the navigation-bar component 140 is especially dramatic when considering the large number of pages impacted by the caching of these components.

2.2 Dated Content Component:

In another representative embodiment, a label, as for example an icon, is placed adjacent to a link indicating that a change has occurred in the page referenced by the link. This label could be, for example, an icon that displays the word “new”. In this example, a particular content module was already cached and comprised a nested, hierarchical display of web resources similar to that of the categories displayed by modern Internet service providers such as Yahoo. Items displayed in each page are labeled with a “new” icon if the contents to which it refers have been recently updated or added. The exact meaning of “new” is defined based upon customer preference. As an example, some customers might want see a “new” icon next to all items that have been updated since the last time he visited the page. Others might want to see “new” icons only next to those items that have been actually updated within some specified time frame, such as yesterday or last week, irrespective of whether they have visited the page during that time or not. The dilemma is whether to make the page that had been previously cached, but which is to be personalized with these “new” icons, cached or dynamic. On the one hand, since each page still contains, except for the “new” icons, the same content for all users, it would be more efficient if the pages were cached. On the other hand, while the underlying content remains the same for all clients, the addition of these “new” icons results in pages that appear different to each user suggests that these pages would need to be made dynamic.

One solution to this problem would be to cache a different version of the content component for each variation of user preference. However, this technique would necessitate either dynamically generating or caching a customized version for every variation of user preferences. The maintenance of such caching schemes on top of the original scheme is a daunting task.

In the representative embodiment, however, only one version of each content-display component 130 is needed, as in the case before personalization. Personalization is achieved through the use of client-side JavaScript functions that turn each “new” icon image associated with an item on or off in a way that satisfies the preferences set by the customer. As an example, the dynamic user preference library 115 can be used to write to the browser a user preference parameter which represents the number of days needed to pass before an item is no longer to be considered “new” by the user. This user preference parameter would be sent to the client's browser via a non-displayed JavaScript variable. A client JavaScript program will toggle the “new” icon image by comparing the item's age to this parameter and turn the “new” icon image on or off depending on whether an item's age has surpassed that threshold. The cached paged is hence personalized, even though HTML behind the cached display is the same. The only difference between the pages sent to each client is the value of JavaScript variable parameter written by the dynamic user preference library 115. While cached components are often implemented in HTML, they can in general be in any format, including the internet information exchange standard XML. As previously stated, information in XML can be converted to HTML, voice interface devices, low screen resolution display, as for example in Personal Digital Assistants (PDA's), pagers, mobile phones, etc. and can be used with virtual reality devices and Internet enabled appliances depending upon the client. Using the ideas presented herein, one can continue to cache the content-display component 130 even as one implements the customized “new” tagging feature.

2.3 Client/Server System:

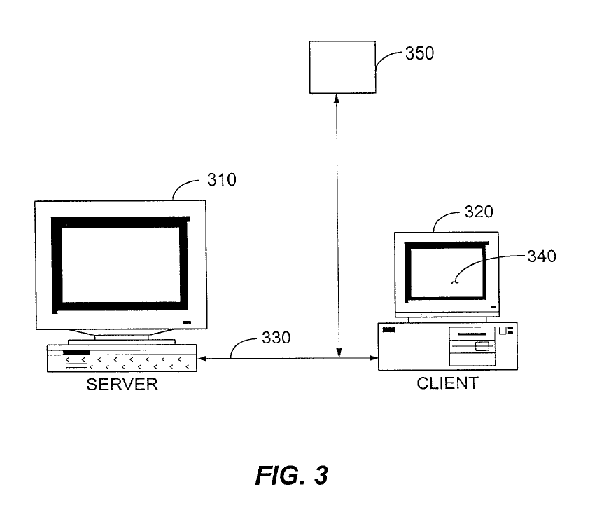

FIG. 3 is a drawing of a server/client 310,320 system as described in various representative embodiments of the present patent document. In FIG. 3, the server 310 is connected to the client 320 via a network 330. A client display 340 is created and displayed on the client 320 from information such as the content-display component 130 and results 140, the navigation-bar component 140 of FIG. 1, obtained from the server 310 and other network sources 350.

2.4 Flow Chart of Method:

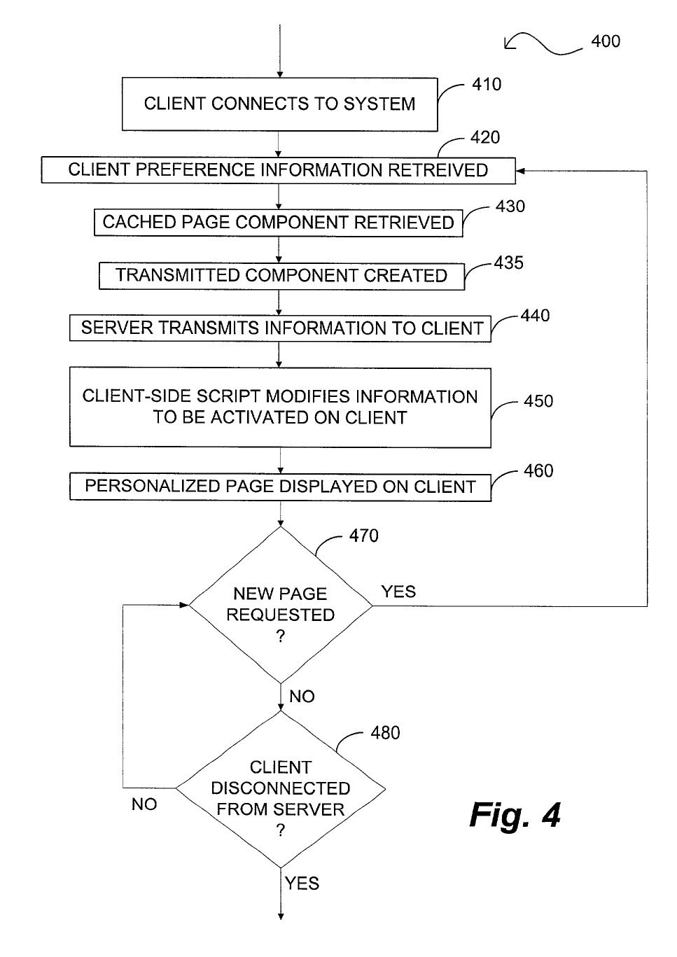

FIG. 4 is a flow chart 400 of a method for display of client enhanced server-side cache pages as described in various representative embodiments of the present patent document.

In block 410, client 320 connects to server 310 on the network 330. Block 410 then transfers control to block 420.

In block 420, client preference information retrieved for client display 340 to be displayed on client 320 by, for example, the dynamic login library 110. Block 420 then transfers control to block 430.

In block 430, the server retrieves the content-display component 130 of the web page which is cached. Block 430 then transfers control to block 435.

In block 435, the server creates the transmitted component 120. Block 430 then transfers control to block 440.

In block 440, sends the transmitted component 120 to the client 320, wherein the transmitted component 120 comprises the client-function component 125 and the client-content-display component 126. Block 440 then transfers control to block 450.

In block 450, the client uses the client-function component 125 to modify the client-content-display component 126 to generate the final personalized version of the client display 340 for display on the client. Block 450 then transfers control to block 460.

In block 460, the personalized page, client display 340, is displayed on the client 320. Block 460 then transfers control to block 470.

When the client has requested a new page, block 470 transfers control to block 420. Otherwise block 470 transfers control to block 480.

When the client has disconnected from the server, block 480 terminates the process. Otherwise block 480 transfers control to block 470.

3. Summary:

The methods disclosed above can be easily implemented in numerous web presentation technologies including but not limited to those implemented in the commercial web page generation technology products Vignette, Java Server Pages (JSP), Active Server Pages (ASP), and Common Gateway Interface (CGI), so long as some type of a file system based cache supporting infrastructure exists. Regardless of the technology, the fundamental goal is to extend a cached page's lifetime even when new personalization requirements are needed. In the above discussions, two cases have been disclosed wherein personalization is achieved on top of static, cached web pages. Links can be personalized to take on different behaviors based on user preference. Images can be turned on or off according to user preference. However, these methods have application beyond link target modification and image on/off display. Links can be associated with customized JavaScript functions to carry even more complicated customized tasks on behalf of the user. Whole sets of images and texts can be substituted, emphasized, hidden or displayed for a more personalized web experience. These can all be done in the context of a high performance, docroot-based caching web site.

Two representative embodiments have been provided which demonstrate effective uses of the proposed methods. By writing the date that a particular page or segment of a page was modified as an invisible field to that page, client side processes, as for example java scripts, can detect whether to display new information, as for example a “new” icon, or not without using any server resources. The cached pages can remain cached until new real content is added. It's common to have multiple servers serving different geographical regions—i.e., Europe, Asian, Americas servers. When pages are cached and transferred between sites, the pages might have to be re-rendered just because certain links now point to different servers. It is also common for login synchronization that pages are a combination of dynamically rendered and statically cached pages. The dynamically rendered side can store server links into either hidden trays on the page or in cookies. Than cached page can remain cached and fetch the dynamic information from the dynamic part via JavaScript.

As is the case, in many data-processing products, the methods disclosed in the present patent document may be implemented as a combination of hardware and software components. Moreover, the functionality require for using the invention may be embodied in computer-readable media, such as for example hard disks, CD ROMs, and 3.5 inch diskettes, to be used in programming an information-processing apparatus, as for example computers such as servers and personal computers to perform in accordance with the invention.

4. Concluding Remarks:

A primary advantage of the embodiment as described in the present patent document over prior methods for caching page content in multi-user environments is the ability of the methods disclosed herein to increase the effectiveness of docroot-based caching systems in the context of the two contradictory demands of greater personalization and higher performance. The mechanism proposed to reconcile some of this dilemma is to use client-side processes, as for example JavaScript, to enable customization to be performed on the client side so that only one, or perhaps at most a few, master cashed versions are needed on the server. A primary goal of the methods disclosed is to maintain as few versions of cached components on the server for as many clients as possible for as long as possible prior to having to regenerate the cached information to increase server performance. Methods described herein provide techniques for attaining this goal.

While the present invention has been described in detail in relation to preferred embodiments thereof, the described embodiments have been presented by way of example and not by way of limitation. It will be understood by those skilled in the art that various changes may be made in the form and details of the described embodiments resulting in equivalent embodiments that remain within the scope of the appended claims.

What is claimed is:

1. A method for preparing rendering information on a server computer capable of being connected to a client system via a network, which comprises the steps of:
on the server:
retrieving a first information component, wherein the first information component is maintained in a cache on the server;
obtaining information specific to the client;
using the first information component and the client specific information to create a second information component, wherein the second information component comprises a client-function component and a client-display component; and
transferring the second information component to the client, wherein the client is capable of:
creating a client display, wherein the client display is created from the client-display component and activation of the client-function component; and
rendering the client display on the client.

2. A method as recited in claim 1, providing the file format of cached information is selected from the group consisting of Extensible Markup Language (XML) and HyperText Markup Language (HTML).

3. A method as recited in claim 1, wherein the step obtaining information specific to the client comprises the use of server dynamic libraries.

4. A method as recited in claim 3, wherein the step obtaining information specific to the client comprises the use of a dynamic login library.

5. A method as recited in claim 3, wherein the step obtaining information specific to the client comprises the use of a dynamic user preference library.

6. A method for rendering information on a client system capable of being connected via a network to a server computer, which comprises the steps of:
wherein the server is capable of:
retrieving a first information component, wherein the first information component is maintained in a cache on the server;
obtaining information specific to the client;
using the first information component and the client specific information to create a second information component, wherein the second information component comprises a client-function component and a client-display component; and
transferring the second information component to the client;
on the client:
creating a client display, wherein the client display is created from the client-display component and activation of the client-function component; and
rendering the client display on the client.

7. A method as recited in claim 6, providing the client is a communication device selected from the group consisting of virtual reality devices, audio devices, low screen resolution display systems, wireless devices, personal digital assistants, pagers, mobile phones, systems for the visually impaired, local area network devices, and Internet enabled appliances.

8. A method as recited in claim 6, wherein the step rendering the client display on the client comprises presentation of the client display as a web page on the client.

9. A method as recited in claim 6, providing the file format of cached information is selected from the group consisting of Extensible Markup Language (XML) and HyperText Markup Language (HTML).

10. A method as recited in claim 6, wherein the step creating the client display comprises obtaining additional information from other network sources and wherein the client display created is dependent upon the additional information.

11. A method as recited in claim 6, wherein the step creating the client display comprises obtaining additional information from sources on the client and wherein the client display created is dependent upon the additional information.

12. A method as recited in claim 6, wherein the step creating the client display is dependent upon information obtained from server dynamic libraries.

13. A method for rendering information on a client system connected via a network to a server computer, which comprises the steps of:
on the server:
retrieving a first information component, wherein the first information component is maintained in a cache on the server;
obtaining information specific to the client;
using the first information component and the client specific information to create a second information component, wherein the second information component comprises a client-function component and a client-display component; and
transferring the second information component to the client; and
on the client:
creating a client display, wherein the client display is created from the client-display component and activation of the client-function component; and
rendering the client display on the client.

14. A method as recited in claim 13, providing the client is a communication device selected from the group consisting of virtual reality devices, audio devices, low screen resolution display systems, wireless devices, personal digital assistants, pagers, mobile phones, systems for the visually impaired, local area network devices, and Internet enabled appliances.

15. A method as recited in claim 13, wherein the step rendering the client display on the client comprises presentation of the client display as a web page on the client.

16. A method as recited in claim 13, providing the file format of cached information is selected from the group consisting of Extensible Markup Language (XML) and HyperText Markup Language (HTML).

17. A method as recited in claim 13, wherein the step creating the client display comprises obtaining additional information from other network sources and wherein the client display created is dependent upon the additional information.

18. A method as recited in claim 13, wherein the step creating the client display comprises obtaining additional information from sources on the client and wherein the client display created is dependent upon the additional information.

19. A method as recited in claim 13, wherein the step obtaining information specific to the client comprises the use of server dynamic libraries.

20. A method as recited in claim 19, wherein the step obtaining information specific to the client comprises the use of a dynamic login library.

21. A method as recited in claim 19, wherein the step obtaining information specific to the client comprises the use of a dynamic user preference library.

22. A program storage medium readable by a server computer, tangibly embodying a software program of instructions executable by the server to perform method steps for preparing rendering information on a client system capable of being connected via a network to the server computer, the method steps comprising:
on the server:
retrieving a first information component, wherein the first information component is maintained in a cache on the server;
obtaining information specific to the client;
using the first information component and the client specific information to create a second information component, wherein the second information component comprises a client-function component and a client-display component; and
transferring the second information component to the client, wherein the client is capable of:
creating a client display, wherein the client display is created from the client-display component and activation of the client-function component; and
rendering the client display on the client.

23. A program storage medium as recited in claim 22, wherein the file format of cached information is selected from the group consisting of Extensible Markup Language (XML) and HyperText Markup Language (HTML).

24. A program storage medium as recited in claim 22, wherein the method step obtaining information specific to the client comprises the use of server dynamic libraries.

25. A program storage medium as recited in claim 24, wherein the method step obtaining information specific to the client comprises the use of a dynamic login library.

26. A program storage medium as recited in claim 24, wherein the method step obtaining information specific to the client comprises the use of a dynamic user preference library.

27. A program storage medium readable by a client system, tangibly embodying a software program of instructions executable by the client to perform method steps for preparing and rendering information on the client, wherein the client is capable of being connected to a server computer via a network, the method steps comprising:
wherein the server is capable of:
retrieving a first information component, wherein the first information component is maintained in a cache on the server;
obtaining information specific to the client;
using the first information component and the client specific information to create a second information component, wherein the second information component comprises a client-function component and a client-display component; and
transferring the second information component to the client;
on the client:
creating a client display, wherein the client display is created from the client-display component and activation of the client-function component; and
rendering the client display on the client.

28. A program storage medium as recited in claim 27, wherein the client is a communication device selected from the group consisting of virtual reality devices, audio devices, low screen resolution display systems, wireless devices, personal digital assistants, pagers, mobile phones, systems for the visually impaired, local area network devices, and Internet enabled appliances.

29. A program storage medium as recited in claim 27, wherein the method step rendering the client display on the client comprises presentation of the client display as a web page on the client.

30. A program storage medium as recited in claim 27, wherein the file format of cached information is selected from the group consisting of Extensible Markup Language (XML) and HyperText Markup Language (HTML).

31. A program storage medium as recited in claim 27, wherein the method step creating the client display comprises obtaining additional information from other network sources and wherein the client display created is dependent upon the additional information.

32. A program storage medium as recited in claim 27, wherein the method step creating the client display comprises obtaining additional information from sources on the client and wherein the client display created is dependent upon the additional information.

33. A program storage medium as recited in claim 27, wherein the method step creating the client display is dependent upon information obtained from server dynamic libraries.

34. An apparatus for preparing rendering information on a server computer capable of being connected to a client system via a network, comprising:
on the server:
means for retrieving a first information component, wherein the first information component is maintained in a cache on the server;
means for obtaining information specific to the client;
means for using the first information component and the client specific information to create a second information component, wherein the second information component comprises a client-function component and a client-display component; and
means for transferring the second information component to the client, wherein the client is capable of:
means for creating a client display, wherein the client display is created from the client-display component and activation of the client-function component; and
means for rendering the client display on the client.

35. An apparatus for rendering information on a client system capable of being connected via a network to a server computer, which comprises the steps of:
wherein the server is capable of:
means for retrieving a first information component, wherein the first information component is maintained in a cache on the server;
means for obtaining information specific to the client;
means for using the first information component and the client specific information to create a second information component, wherein the second information component comprises a client-function component and a client-display component; and
means for transferring the second information component to the client;
on the client:
means for creating a client display, wherein the client display is created from the client-display component and activation of the client-function component; and
means for rendering the client display on the client.
